(19) United States
(12) Patent Application Publication
(10) Pub. No.: US 2024/0353713 A1
(43) Pub. Date: Oct. 24, 2024

(54) SWITCHABLE ALIGNMENT LAYER FOR LIQUID CRYSTAL DISPLAYS CAPTURE

(71) Applicants: Meta Platforms Technologies, LLC, Menlo Park, CA (US); University of Groningen, Groningen (NL)

(72) Inventors: Jasmine Soria Sears, Portland, OR (US); Gareth Valentine, Kirkland, WA (US); Ruben Feringa, Groningen (NL); Wesley Richard Browne, Groningen (NL)

(21) Appl. No.: 18/639,258

(22) Filed: Apr. 18, 2024

Related U.S. Application Data
(60) Provisional application No. 63/460,455, filed on Apr. 19, 2023.

(51) Int. Cl. G02F 1/1337; C09K 19/38; G02F 1/137

(52) U.S. Cl. CPC G02F 1/133711; C09K 19/38; G02F 1/13718; C09K 2323/02

(57) ABSTRACT

A display cell of the subject technology includes two electrodes electrically coupled with a voltage supply, two alignment layers formed over surfaces of the two electrodes, and a liquid crystal (LC) material layer embedded between the two alignment layers. The alignment layers includes grooves and molecules of the LC material layer that are enabled to align along the grooves when no voltage is applied to the two electrodes. The two alignment layers include a polymer formed with a combination of an electron-donor monomer and an electron-acceptor monomer.

### CROSS-REFERENCE TO RELATED APPLICATIONS

The present disclosure is related and claims priority under 35 USC § 119(e) to U.S. Provisional Application No. 63/460,455, entitled “SWITCHABLE ALIGNMENT LAYER FOR LIQUID CRYSTAL DISPLAYS,” filed on Apr. 19, 2023, the contents of which are herein incorporated by reference, in their entirety, for all purposes.

### BACKGROUND

### Technical Field

The present disclosure is related generally to the liquid crystals, and more specifically, the present disclosure is related to switchable alignment layers for increasing the dynamic range between transparency and opacity of a liquid crystal cell.

### Related Art

Liquid crystal displays (LCDs) typically use alignment polymer hosts that set a default configuration for the LC matrix, for example, aligned with a throughput polarization state, or rotating along a cross polarization path. These default configurations are attained due to the strong coupling between the host polymer and the LC molecules, and the ability of the LC molecules to propagate an alignment configuration across the thickness of the LC layer. However, the coupling between alignment layers and LC molecules results in residual alignment even when the LC display is activated. This causes a response lag and a residual transparency and/or darkness of the display, which limits its dynamic range, hinders its applicability and affects the user comfort.

### SUMMARY

An aspect of the subject technology is directed to a display cell that includes two electrodes electrically coupled with a voltage supply, two alignment layers formed over surfaces of the two electrodes, and a liquid crystal (LC) material layer embedded between the two alignment layers. The alignment layers include grooves and molecules of the LC material layer that are enabled to align along the grooves when no voltage is applied to the two electrodes. The two alignment layers include a polymer formed with a combination of an electron-donor monomer and an electron-acceptor monomer.

Another aspect of the disclosure is related to a display panel including an LC panel including a plurality of LC cells arranged in a planar configuration. Each LC cell of the plurality of LC cells include electrode layers to be electrically coupled with a voltage supply, alignment layers adjacent to the electrode layers, and a layer of LC molecules embedded between the alignment layers. The alignment layers include a polymer formed with a combination of an electron-donor monomer and an electron-acceptor monomer. The alignment layers include grooves, and the LC molecules are enabled to align along the grooves when no voltage is applied to the electrode layers.

Yet another aspect of the disclosure is related to a method including forming a first multilayer structure over a first glass substrate and forming a second multilayer structure over a second glass substrate. The method further includes embedding an LC material layer between the first multilayer structure and the second multilayer structure. The first multilayer structure includes a first electrode, a first alignment layer and a first polymer layer. The second multilayer structure includes a second electrode, a second alignment layer and a second polymer layer. The first polymer layer and the second polymer layer include a combination of an electron-donor monomer and an electron-acceptor monomer.

### BRIEF DESCRIPTION OF THE DRAWINGS

To easily identify the discussion of any particular element or act, the most significant digit or digits in a reference number refer to the figure number in which that element is first introduced.

FIG. 1 is a schematic diagram illustrating an example of a headset for virtual reality (VR), augmented reality (AR) and mixed reality (MR) applications, according to some aspects of the subject technology.

FIGS. 2A and 2B are schematic diagrams illustrating examples of different configurations and a display application of LC displays, as disclosed herein.

FIGS. 3A and 3B are schematic diagrams illustrating comparisons between an example of an LC cell having a regular cell and an example of a cell including a redox-activatable alignment layer, according to some aspects of the subject technology.

FIGS. 4A and 4B are schematic diagrams illustrating examples of an interaction of a redox-activatable alignment polymer with LC molecules, according to some aspects of the subject technology.

FIGS. 5A and 5B are schematic diagrams illustrating examples of chemical composition and structure of some exemplary redox-activatable polymers that may be used for an LCD, according to some aspects of the subject technology.

FIGS. 6A and 6B are charts illustrating examples of the performance of LC cells in cholesteric phase with and without a redox-activatable alignment layer, according to some aspects of the subject technology.

FIG. 7 is a schematic diagram illustrating an example of performance of an LC panel including a redox-activatable alignment layer, according to some aspects of the subject technology.

FIG. 8 is a flow diagram illustrating a method for providing an LCD panel, according to some aspects of the subject technology.

In the figures, elements having the same or similar reference numerals are associated with the same or similar attributes, unless explicitly stated otherwise.

### DETAILED DESCRIPTION

In the following detailed description, numerous specific details are set forth to provide a full understanding of the present disclosure. It will be apparent, however, to one ordinarily skilled in the art, that embodiments of the present disclosure may be practiced without some of these specific details. In other instances, well-known structures and techniques have not been shown in detail so as not to obscure the disclosure. Embodiments as disclosed herein will be described with the description of the attached figures.

According to some aspects, the subject technology provides an LC cell including two electrode layers, which can be electrically coupled to a voltage supply and two alignment layers adjacent to the electrode layers. The alignment layers include linearly oriented grooves, and a layer of liquid crystal molecules is formed between the alignment layers and the electrode layers. The LC molecules are aligned along the linearly oriented grooves when no voltage is applied to the electrode layers, and the liquid crystal molecules disengage from the alignment layers when a voltage is applied to the electrode layers.

LC cells are constructed by applying a coating to the surface of a material (electrode) which is used for a liquid crystal cell. This coating is scratched in a way to induce an alignment of the liquid crystalline molecules that are formed above the grooves. The alignment of the LC molecules at each electrode relative to one another determines the liquid crystalline phase obtained. The alignment is usually on one or both sides, and the effect of the alignment on the behavior of the liquid crystal is fixed at constant temperature and depends on the thickness of the liquid crystal layer (persistence length). When a potential is applied between the two electrodes, across the liquid crystal layer, eventually the LC molecules align with the direction of the applied field (the Fréedericksz transition). The transition is observed only when the potential is strong enough to overcome the influence of the alignment surface (scratched polymer coating) on the LC molecules. This point is reached first in the middle of the liquid crystal layer and only as the strength of the electric field (potential) increases, LC molecules adjacent to the electrodes begin to align. However, in proximity to the electrode surface, the effect of the electric field may not be sufficient to overcome the effect of the alignment layer.

Typically, a high percentage of the liquid crystal mixture is aligned with the electric field during switching from the resting state to a state enforced by the electric field. However, a percentage of the liquid crystal molecules near the surface is more affected by the surface structure than the electric field and remains in its original configuration. This small part of non-aligned LC molecules reduces optical performance of the cell. The residual retardation is a deleterious effect in LC applications caused by the LC molecules sticking to the host polymer in the alignment layer at the end of the LC cells, even at moderate voltage levels.

To resolve the above problem, embodiments disclosed herein include a redox-activatable polymer over the surfaces of the alignment layer at the interface between the LC molecules and the electrodes. An applied voltage induces oxidation (adjacent to the anode, or ‘positive’ electrode) or reduction (adjacent to the cathode, or ‘negative’ electrode) of the alignment layer, largely eliminating surface interaction with the LC molecules. The liquid crystal molecules are then left free to align according to the applied electric field even adjacent to the alignment layer, as desired.

Accordingly, embodiments as disclosed herein include alignment layers with redox-activatable polymers that can oxidize (anode) and reduce (cathode) reversibly, upon application of a voltage.

In some embodiments, the alignment layer adjacent to the cathode or anode may include a similar polymer formed with similar amounts of reducing and oxidizing monomers. Thus, the directionality of the field is irrelevant. Accordingly, AC activation of LC cells, as disclosed herein, is possible and symmetric. In some implementations, a polymer for an alignment layer as disclosed herein includes a first component that is oxidizable and a second component that is reducible, in any proportion, according to a desired activation characteristic. In some implementations, an alignment layer adjacent to the anode may include a polymer having only an oxidizing component. The oxidizing component can be, for example, a redox-activatable polymer film that may be formed by polymerization of a monomer such as diadamantyl ether (DAE) 4,4′″-(perfluorocyclopent-1-ene-1,2-diyl)bis(5-methyl-2,2′:5′,2″-terthiophene), or a component that can be oxidized and a component that can be reduced (e.g., poly-allophycocyanin-naphthalene diimide (APC-NDI) formed from the monomer 2,7-bis(4-(9H-carbazol-9-yl)phenyl)benzo[lmn][3,8]phenanthroline-1,3,6,8(2H,7H)-tetraone, or other Amino-phenyl carbazole Naphtalene diimides). Likewise, the alignment layer adjacent to the cathode may include only a reducible component. Each configuration may optimize the activation characteristics of the LC cell.

In some embodiments, it is desirable that the oxidation potential of the alignment polymer be less positive than the oxidation (or ionization) potential of the LC molecule. Likewise, it is desirable that the reduction potential of the alignment polymer be less negative than the reduction (or electron affinity) potential of the LC molecule.

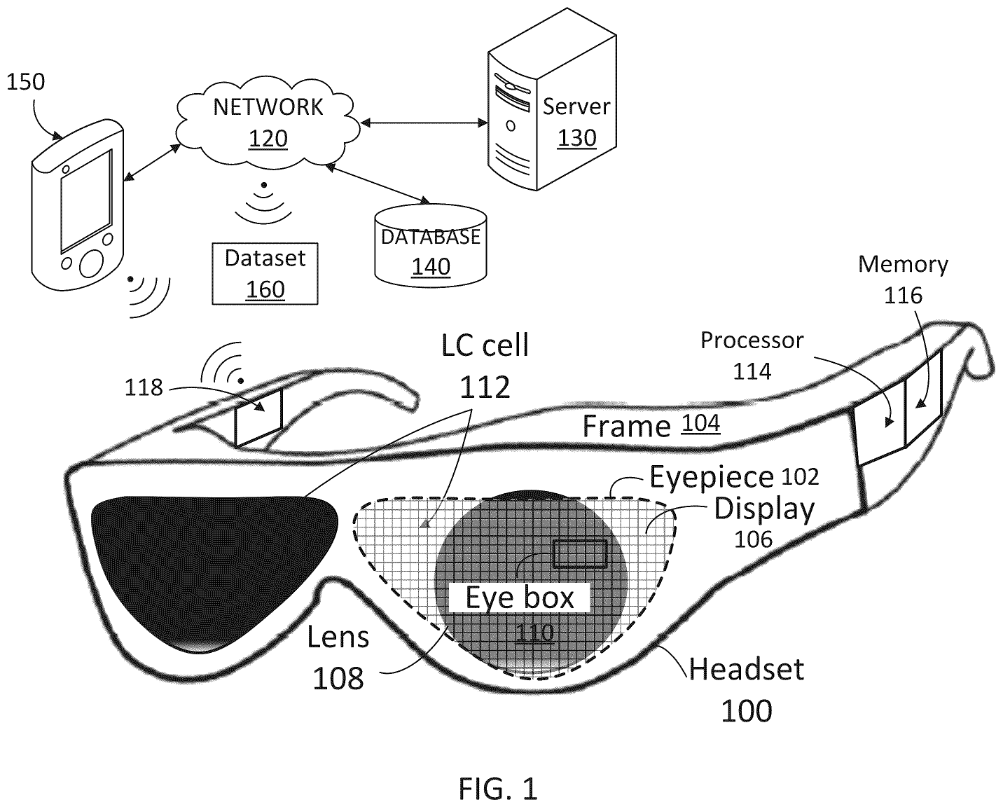

Now turning to the description of figures, FIG. 1 is a schematic diagram illustrating an example of a headset 100 for virtual-reality (VR), augmented-reality (AR), mixed-reality (MR) or immersive-reality (IR) applications, according to some aspects of the subject technology. The eyepieces 102 are mounted on a frame 104 and provide a transmitted image from the real world to a headset user. In some embodiments, a display 106 may also be configured to provide a computer-generated image to the headset user (e.g., for AR/VR/MR/IR applications). The lens 108 optically couples the display 106 to an eye box 110 delimiting an area where a user's pupil is located.

At least one of the eyepieces 102 or the lens 108 includes an LC cell 112, as disclosed herein. Accordingly, the LC cell 112 may include a liquid crystal layer sandwiched between polymer aligning layers, and electrode layers (not shown here for simplicity). The electrode layers provide an electric field that aligns the LC molecules in the LC layer along the electric field. The polymer alignment layer provides a default alignment of the LC molecules in the LC layer, absent an electric field across the electrode layer. The disclosed polymer alignment layer includes a redox-activatable layer, such that the polymer is oxidized by the positive electrode (anode) and reduced by the negative electrode (cathode) once the voltage surpasses a pre-determined threshold. When the electrodes are activated, the polymer alignment layer is oxidized (anode) and reduced (cathode), thus losing its ability to attach with LC molecules of the LC layer, which become free to align with the electric field. An LC layer as disclosed herein may be used in one or both eyepieces 102 as a transparency controller. For example, the user may desire a high transparency in an area of an eyepiece that provides a real-world throughput image. When a portion of the eyepiece is used to display a computer-generated image or icon, it is desirable that the background of the eyepiece be opaque. In one or more implementations, the lens 108 coupling the display 106 or eyepiece 102 to the eye box 110 may include a pancake lens, a Pancharatnam Berry phase lens, an active grating (e.g., surface relief grating or volumetric Bragg grating), and the like, which uses switchable polarization components having LC layers as disclosed herein.

The headset 100 may include a processor circuit 114 and a memory circuit 116. The memory circuit 116 may store instructions which, when executed by processor circuit 114, cause the headset 100 to provide the computer-generated image. In addition, the headset 100 may include a communications module 118. The communications module 118 may include radio-frequency software and hardware configured to wirelessly communicate with the processor circuit 114 and the memory circuit 116, with a network 120, a remote server 130, a database 140, or a mobile device 150 handled by the user of the headset 100. The headset 100, mobile device 150, remote server 130, and database 140 may exchange commands, instructions, and data, via a dataset 160, through the network 120. Accordingly, the communications module 118 may include radio antennas, transceivers, and sensors, and also digital processing circuits for signal processing according to any one of multiple wireless protocols such as Wi-Fi, Bluetooth, Near field contact (NFC), and the like. In addition, the communications module 118 may also communicate with other input tools and accessories cooperating with the headset 100 (e.g., handle sticks, joysticks, mouse, wireless pointers, and the like). The network 120 may include, for example, any one or more of a local area network (LAN), a wide area network (WAN), the Internet, and the like. Further, the network 120 can include, but is not limited to, any one or more of the following network topologies, including a bus network, a star network, a ring network, a mesh network, a star-bus network, tree or hierarchical network, and the like.

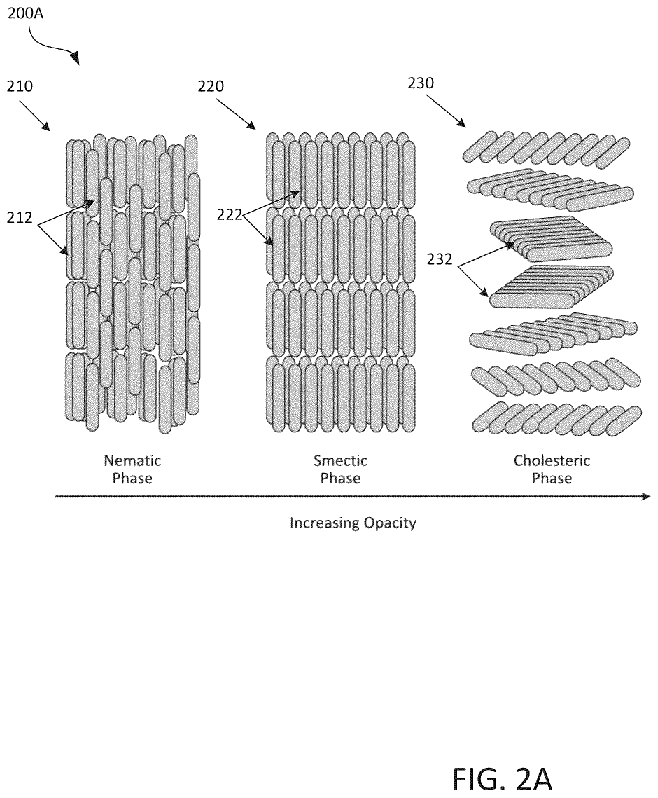

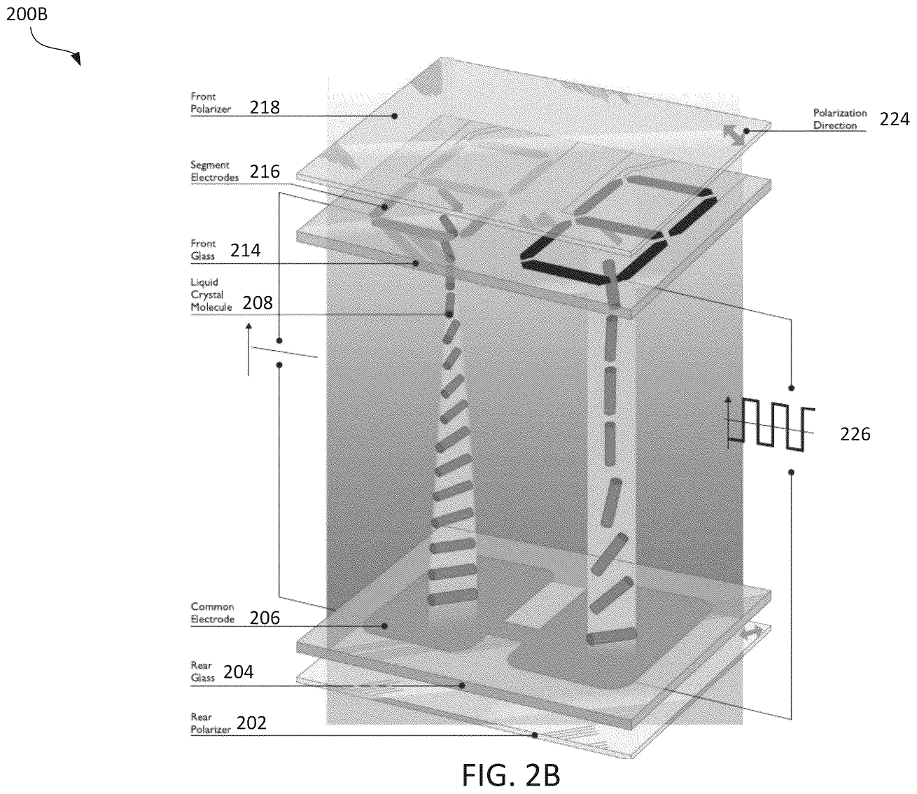

FIGS. 2A and 2B are schematic diagrams illustrating examples of a configuration 200A and a display application of an LCD 200B, as disclosed herein. LC materials are used in various applications in day-to-day life, for example, in LCD screens. The configuration 200A of FIG. 2A illustrates different LC states 210, 220 and 230 adopted by LC layers. The LC states 210, 220 and 230 are cholesteric, smectic, and nematic LC states (also referred to as phases or configurations), respectively, each with its own properties and optical transparencies. Nematic and smectic LC states 210 and 220 are states of LC molecules that exhibit both fluid and solid properties. In the nematic LC state 210, the molecules 212 are aligned in parallel chains while in the smectic LC state 220, the molecules 222 are aligned in layers, while in a nematic LC state 210, LC molecules can organize in layers with no positional ordering within layers, but with a director axis which varies with layers. A cholesteric LC is a type of LC, in which 232 form a helical structure, and which is therefore chiral. The light passing through the cholesteric LC state 230 changes in its linear polarization, which is the basis for LCDs.

FIG. 2B illustrates a display application of the LCD 200B as disclosed herein. The LCD 200B includes structural components including a rear polarizer 202, a rear glass 204, a common electrode 206, LC molecules 208, a front glass 214, segment electrodes 216 and a front polarizer 218. The LC molecules 208 are sandwiched between the rear glass 204 and the front glass 214. The front polarizer 218 and the rear polarizer 202 are used to change a polarization direction 224. The common electrode 206 can be made of indium-tin-oxide (ITO). The structural components form a 2D LCD panel. The 2D structured interfaces are oriented at 900 with respect to each other to create a twist in the liquid crystal alignment, which generates the cholesteric phase. An alignment layer of redox-activatable host polymers adjacent to the cell electrodes give the cholesteric phase orientation in the resting state (e.g., no voltage applied). Applying an electric field across a cell containing cholesteric LC states (bright pixel) brings them to a nematic LC state, as the molecules align with the electric field (dark pixel). The electric field can be generated by a signal 226 applied between common electrodes 206 and the segment electrodes 216. Since the pixels of the LCD 200B are placed between two polarizers (rear polarizer 202 and front polarizer 218) in an orthogonal polarization with respect to each other, light is transmitted when an electric field is not applied. Due to the reduced interaction between the redox-activated alignment layer and the LC molecules, any residual light transmission when the LC cell is ‘on’ is substantially suppressed, as desired.

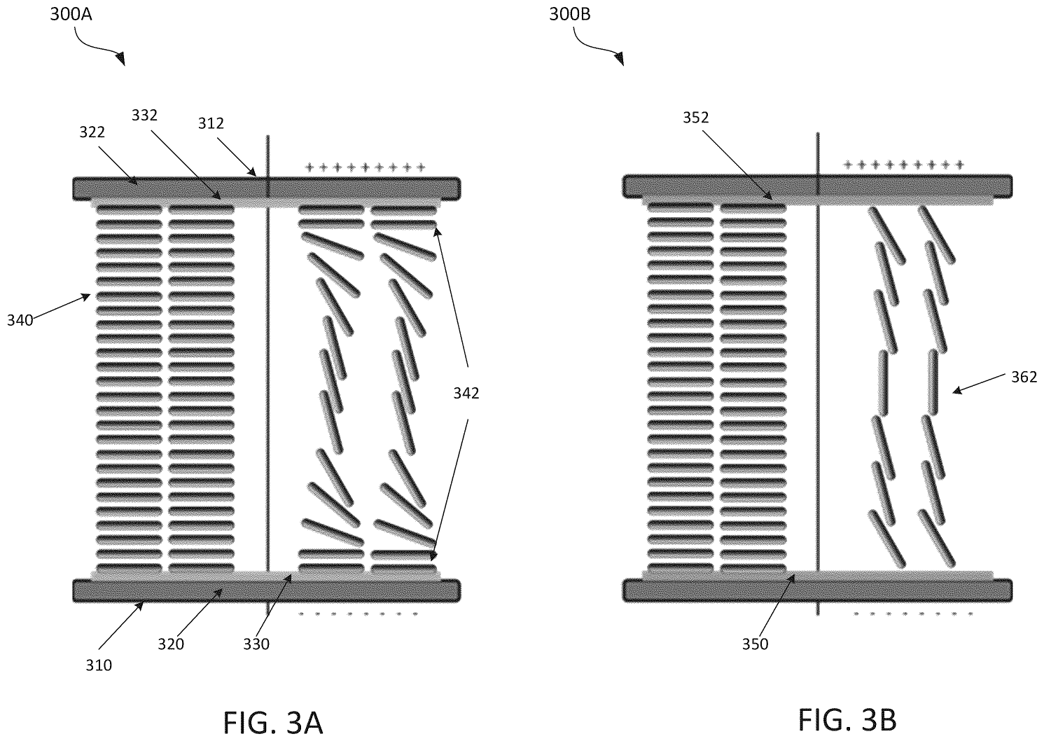

FIGS. 3A and 3B are schematic diagrams illustrating comparisons between examples of an LC cell 300A having a regular cell and an LC cell 300B including a redox-activatable alignment layer, according to some aspects of the subject technology. FIG. 3A illustrates a first multilayer structure including a first polymer layer 330 coated on the surface of a first alignment layer 320. The first alignment layer 320 is formed on a first electrode 310 (cathode). Similarly, a second multilayer structure includes a second polymer layer 332 coated on the surface of a second alignment layer 322, which is, in turn, is formed on a second electrode 312 (anode). An LC material layer 340 is embedded between the first multilayer structure and the second multilayer structure. The first and the second polymer layers 330 and 332 can force the alignment of the molecules of the LC material layer 340. In response to applying a voltage (shown by the plus and minus signs) across the electrodes 310 and 312, a portion of the molecules of the LC material layer 340, which are in the middle of the LC layer, align with the electric field (Fréedericksz transition). However, LC molecules 342 adjacent to the polymer layers 330 and 332 remain pinned to the original alignment of the LC material layer 340.

FIG. 3B illustrates a redox-activatable alignment layer (e.g., coated with APC-NDI polymer) of the subject technology. The structure shown in FIG. 3B is similar to the structure of FIG. 3A, except that the polymer layers 330 and 332 are replaced with redox-activatable polymer layers 350 and 352. Using the disclosed redox-activatable polymer layers 350 and 352 resolves the above problem associated with the LC molecules 342, which had remained pinned to the original alignment of the LC material layer 340. The redox-activatable polymer layers 350 and 352 are activated by using redox-activation (e.g., a change in surface polarity) induced by the applied voltage. The activated polymer layers can suppress the interaction between the alignment layers 320 and 322 and the LC molecules 342. Accordingly, the LC molecules 342 are released from the surface of the polymer layers 330 and 332 and are allowed to fully align with the electric field (LC molecules 362). The applied voltage induces oxidation (adjacent to the anode, or ‘positive’ electrode) or reduction (adjacent to the cathode, or ‘negative’ electrode) of the alignment layer, largely eliminating surface interaction with the LC molecules. The liquid crystal molecules are then left free to align according to the applied electric field even adjacent to the alignment layer, as desired.

Accordingly, embodiments as disclosed herein include alignment layers 320 with redox-activatable polymers that can be oxidized (at the anode side) and reduced (at the cathode side) reversibly, upon application of a voltage. The LC layer as disclosed herein may be used in one or both eyepieces 102 as a transparency controller, as described above.

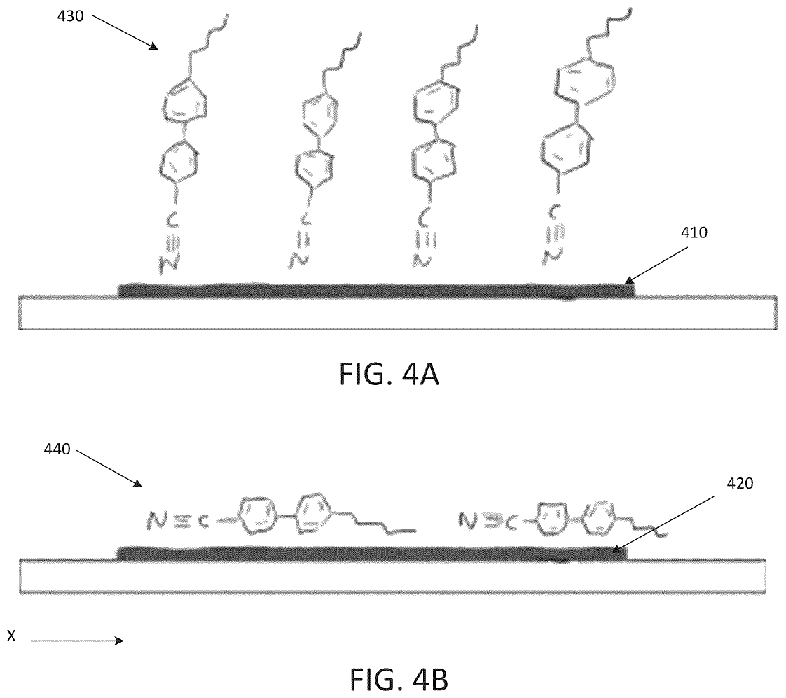

FIGS. 4A and 4B are schematic diagrams illustrating examples of an interaction of a redox-activatable alignment polymer with LC molecules, according to some aspects of the subject technology. FIG. 4A illustrates an activated redox-activatable alignment layer 410 that is activated by an applied potential (positive or negative, notwithstanding), as discussed above. The activated redox-activatable alignment layer 410 is formed at an interface with an LC layer 430 and releases the LC molecules of the LC layer 430, which then align in the general direction of the electric field (which is orthogonal to the equipotential surface defined by the electrode).

FIG. 4B illustrates the inactive redox-activatable alignment layer 420 strongly interacting with the LC molecules of the LC layer 440, which align along the grooves of the alignment layer (e.g., in the plane of the electrode). As mentioned above, the alignment layers include linearly oriented grooves along the shown X-axis, over which the redox-activatable polymer is coated.

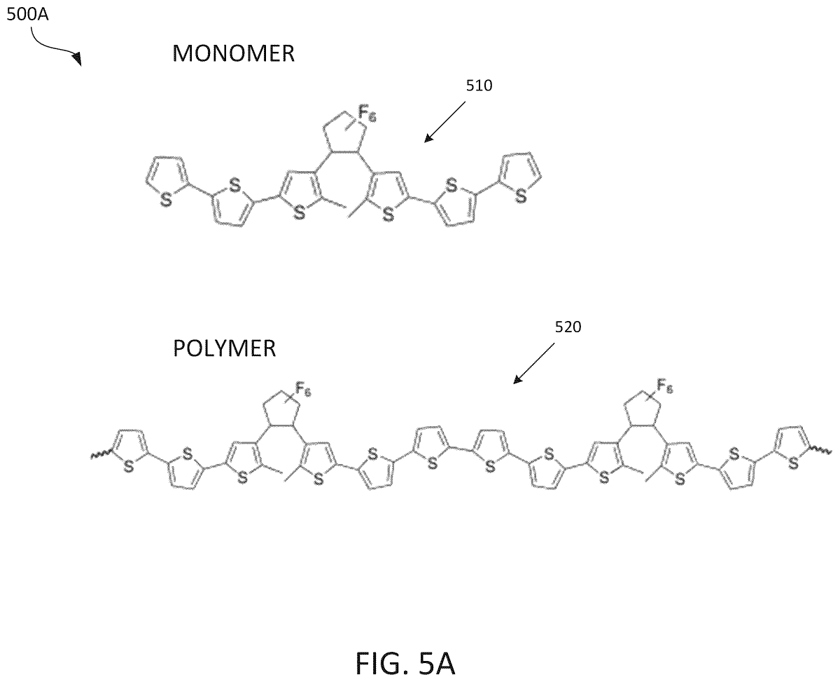

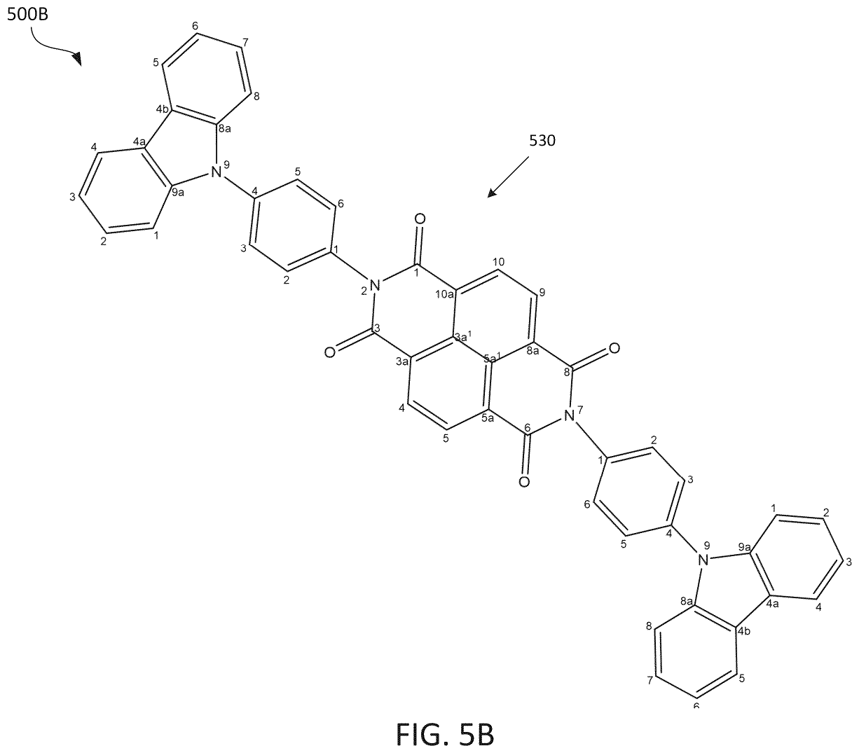

FIGS. 5A and 5B are schematic diagrams illustrating examples of chemical composition and structure of an exemplary redox activatable polymer that may be used for an LCD, according to some aspects of the subject technology. A redox-activatable alignment layer may be synthesized either by spin-coating a polymer on an electrode surface or deposited directly on the electrode surface using an electrochemical polymerization. The electrochemical polymerization or electro-polymerization is a process based on the deposition of the polymer onto the surface of a solid electrode material. This occurs through a generally accepted mechanism that involves the formation of cationic radical by the oxidation of a monomer on the solid electrode material. In direct deposition on the electrode surface, a redox active polymer is combined with an electro-polymerizable material.

FIG. 5A illustrates a molecular structure 500A of a redox-activatable polymer 520, which is formed based on a monomer 510. The monomer 510 is a DAE 4,4″-(perfluorocyclopent-1-ene-1,2-diyl)bis(5-methyl-2,2′:5′,2″-terthiophene) monomer, which can be electro-polymerized to form the redox-activatable polymer 520. This electrochemical polymerization includes preparing a solution of DAE (3, 1 mM) and tetrabutylammonium hexafluorophosphate (TBAPF₆) (0.1 M) in dichloromethane. The monomer mixture is transferred to a glass beaker together with an ITO slide electrode connected to a working electrode, a platinum (Pt) wire or Pt mesh as counter electrode (depending on size of ITO slide) and silver (Ag) or silver chloride (AgCl) as reference electrode. The polymerization includes voltammetry cycling from 0 to 1.2 V with a scan rate of 0.05 V/s and multiple segments depending on the desired thickness of the coating. The coating on the ITO slide can be subsequently rinsed with dichloromethane (DCM) and ethyl alcohol (EtOH) and air dried.

FIG. 5B illustrates a molecular structure 500B of a redox-activatable polymer 530. The redox-activatable polymer 530 is an APC-NDI polymer that can be electro-polymerized using the following steps. In a first step, a solution of 0.1 M TBAPF₆ electrolyte in DCM is made (391 mg in 10 mL) and an APC-NDI (7.5 mg) monomer is added to the solution to get to a concentration of 1 mM APC-NDI. In the second step, the monomer containing solution is transferred in a beaker glass together with an ITO slide as working electrode, Pt wire as counter electrode and Ag/AgCl as a reference electrode. In the final step, the polymerization is conducted by cyclic voltammetry from 0 to 1.4 V with a scan rate of 0.1 V/s. The final step can be performed potentiostatically, which is a polarization technique that allows for the controlled polarization of metal surfaces in electrolytes.

The coating can also be prepared by oxidation of the material in situ followed by application to the ITO slide by spin-coating. The coating can be prepared by drop casting the monomer followed by application of a sufficiently positive potential to oxidize the monomer and form the polymer. The coating on the ITO slide can be rinsed with dichloromethane and ethanol. Two ITO slides, one with and one without coating, were placed on top of each other with a spacer of mylar (25 μm) and a solution of propylene carbonate with 0.1 M of TBAPF₆ was used as electrolyte in between the slides. Spectro-electrochemical measurements demonstrate the optical switching of electro-polymerization of the APC-NDI monomer.

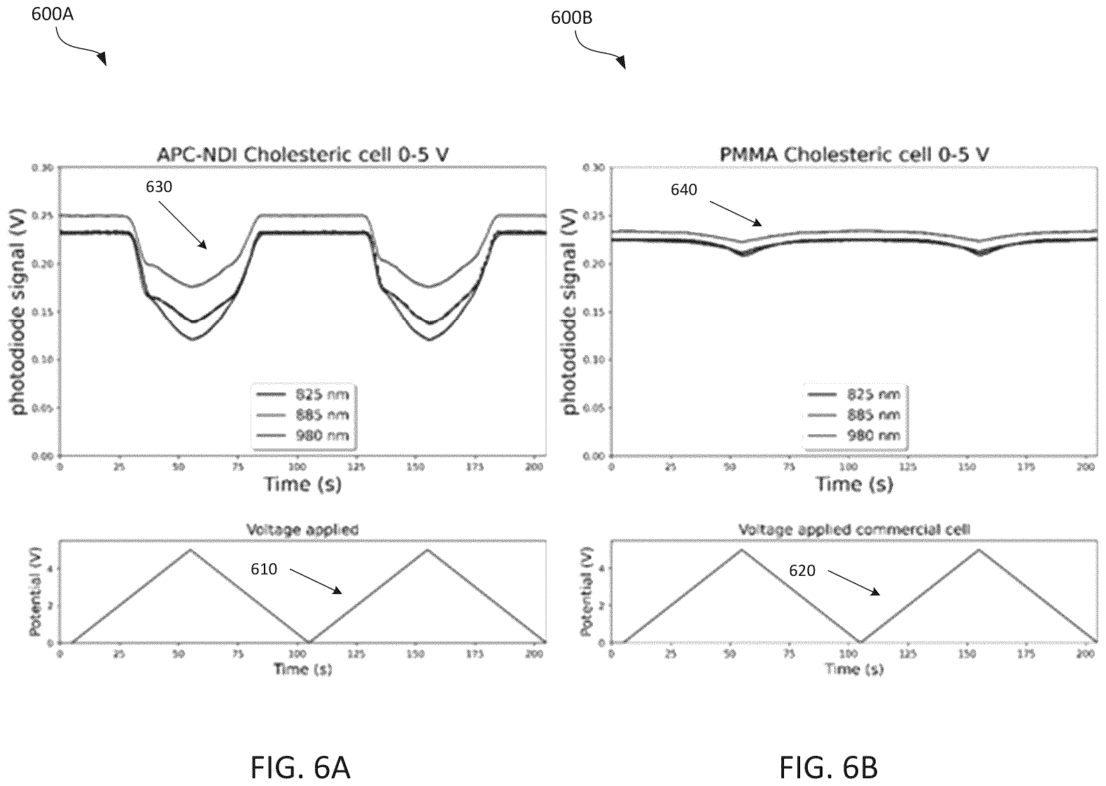

FIGS. 6A and 6B are charts 600A and 600B illustrating examples of the performance of LC cells in cholesteric phase with and without a redox-activatable alignment layer, according to some aspects of the subject technology. The difference between the two cells is only a redox-activatable coating (as discussed above with respect to FIGS. 5A and 5B) compared to a non-redox active polymer. The light transmittance is significantly different between the two cells when a voltage is applied.

FIG. 6A is a chart 600A, which illustrates a first performance associated with a redox activatable alignment layer that includes an APC-NDI polymer (cf. FIG. 4B) twist aligned on ITO coated glass slides subjected to a voltage from 0-5 V followed by optical transmission between crossed polarizers (cf. FIG. 2B). The first performance is indicated by plots 630, which show multiple photodiode signals at different wavelengths (825, 885 and 980 nm) for the applied voltage shown by a plot 610.

FIG. 6B illustrates a second performance associated with an LC cell with an alignment layer including a polymethyl methacrylate (PMMA) polymer. The PMMA is twist aligned on ITO coated glass slides subjected to a voltage from 0-5 V followed by optical transmission between crossed polarizers. The second performance is indicated by plots 640, which show multiple photodiode signals at different wavelengths (825, 885 and 980 nm) for the applied voltage shown by a plot 620. The applied voltage of plot 620 is the same as the applied voltage of plot 610. However, the photodiode signals of plots 630 are appreciably stronger than the photodiode signals of plots 640, which is an indication of performance improvement of the disclosed redox activatable alignment layer compared to a non-redox activatable alignment layer.

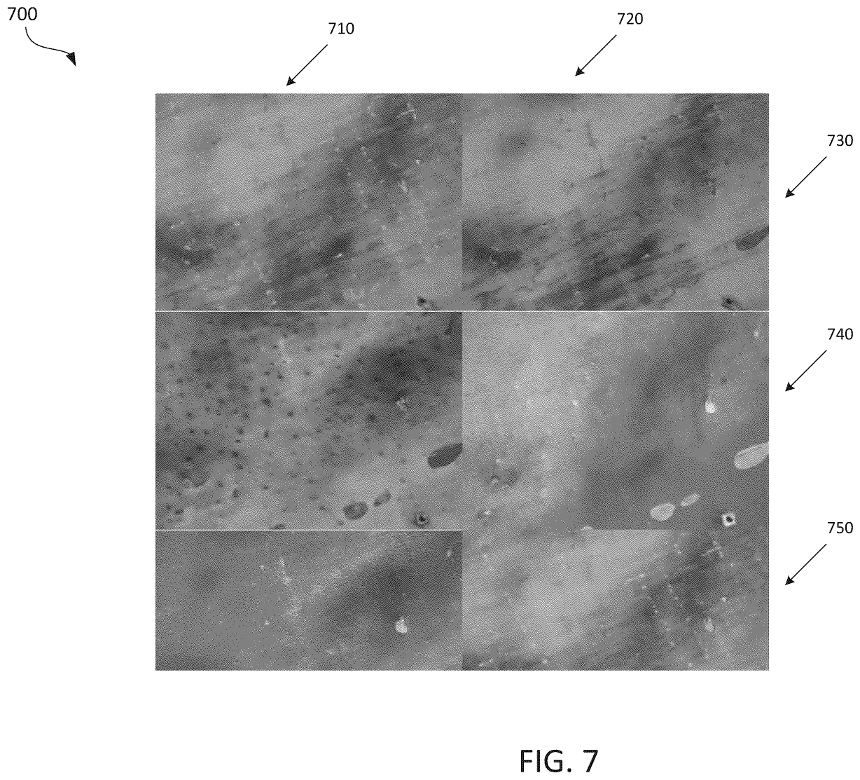

FIG. 7 is a schematic diagram illustrating an example of performance 700 of an LC panel including a redox activatable alignment layer, according to some aspects of the subject technology. In column 710, the images illustrate a color pattern obtained under no voltage activation of the LC layer. In column 720, the color pattern switches as the LC layer is activated by applying a voltage. The color switch is indicative of the different throughput of crossed polarized light at different wavelengths. The overlap in the corresponding patterns (of columns 710 and 720) for each row of rows 730, 740 and 750 indicates the significantly reduced residual retardation between the active/inactive states of the LC panel.

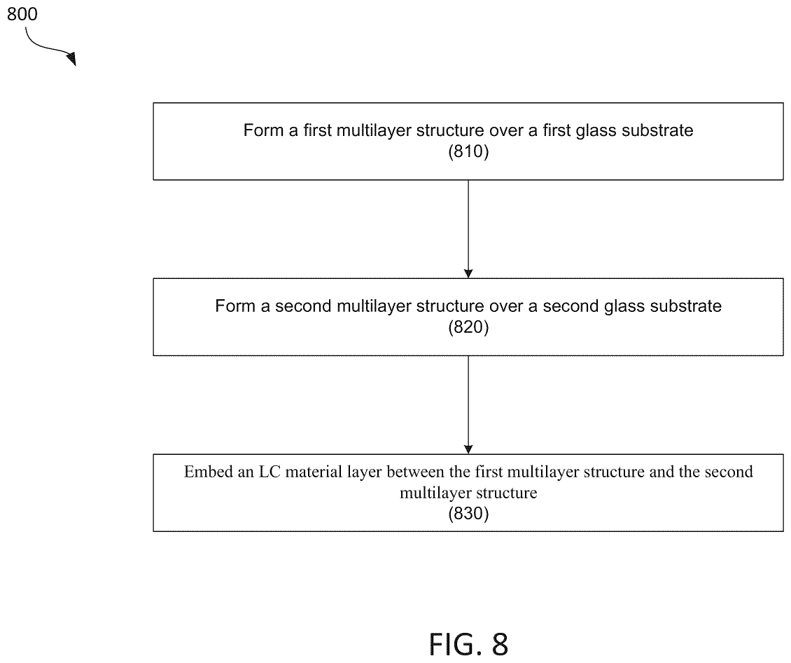

FIG. 8 is a flow diagram illustrating a method 800 for providing an LCD panel, according to some aspects of the subject technology. In some embodiments, at least one step in the method 800 may be executed by a processor circuit (e.g., 114 of FIG. 1) reading instructions from a memory circuit (e.g., 116 of FIG. 1). The processor circuit and the memory circuit may be in a headset (e.g., 100 of FIG. 1, such as a VR headset), a remote server (e.g., 130 of FIG. 1), a mobile phone (e.g., 150 of FIG. 1) and/or a database (e.g., 140 of FIG. 1), as disclosed herein. The headset, remote server, mobile phone and database may be communicatively coupled via a network (e.g., 120 of FIG. 1), by a communications module.

In some embodiments, methods consistent with the present disclosure may include at least one or more of the steps in method 800 performed in a different order, simultaneously, quasi-simultaneously, or overlapping in time.

Step 810 includes forming a first multilayer structure (e.g., including 310, 320 and 330 of FIG. 3) over a first glass (e.g., 204 of FIG. 2B).

Step 820 includes forming a second multilayer structure (e.g., including 312, 322 and 332 of FIG. 3) over a second glass (e.g., 214 of FIG. 2B).

Step 830 includes embedding an LC material layer (e.g., 330 of FIG. 3) between the first multilayer structure and the second multilayer structure.

The first multilayer structure includes a first electrode (310 of FIG. 3), a first alignment layer (320 of FIG. 3) and a first polymer layer (330 of FIG. 3). The second multilayer structure includes a second electrode (312 of FIG. 3), a second alignment layer (322 of FIG. 3) and a second polymer layer (332 of FIG. 3). The first polymer layer and the second polymer layer include a combination of an electron-donor monomer and an electron-acceptor monomer.

Embodiments disclosed herein include alignment layers with redox-activatable polymers that can oxidize (anode) and reduce (cathode) reversibly, upon application of a voltage. The redox-activatable alignment layers of the subject technology show a better performance, as indicted by the plots 630 of FIG. 6A.

An aspect of the subject technology is directed to a display cell (e.g., 300A of FIG. 3A) that includes two electrodes (e.g., 310 and 312 of FIG. 3) electrically coupled with a voltage supply, two alignment layers (e.g., 320 and 322 of FIG. 3A) formed over surfaces of the two electrodes, and a liquid crystal (LC) material layer (e.g., 340 of FIG. 3A) embedded between the two alignment layers. The alignment layers include grooves and molecules of the LC material layer that are enabled to align along the grooves when no voltage is applied to the two electrodes. The two alignment layers include a polymer formed with a combination of an electron-donor monomer and an electron-acceptor monomer.

In some implementations, the surfaces of the two electrodes are facing the LC material layer.

In one or more implementations, the molecules of the LC material layer are enabled to disengage from the alignment layers when no voltage is applied to the two electrodes.

In some implementations, the two electrodes include an anode and a cathode, wherein the two alignment layers include a first alignment layer and a second alignment layer adjacent to the anode and the cathode, respectively.

In one or more implementations, the first alignment layer includes an electron-donor monomer configured to oxidize at a first threshold below a first voltage applied to the anode.

In some implementations, the second alignment layer includes an electron-acceptor monomer configured to reduce at a second threshold above a second voltage applied to the cathode.

In one or more implementations, the grooves include linearly oriented grooves, wherein the linearly oriented grooves are perpendicular to each other, and wherein the molecules of the LC material layer are formed in a cholesteric configuration.

In some implementations, the linearly oriented grooves are parallel to each other, wherein the molecules of the LC material layer are formed in a nematic or a smectic configuration.

Another aspect of the disclosure is related to a display panel (e.g., 200B of FIG. 2B) including an LC panel including a plurality of LC cells (e.g., 300A of FIG. 3A) arranged in a planar configuration. Each LC cell of the plurality of LC cells include electrode layers (e.g., 310 and 312 of FIG. 3A) to be electrically coupled with a voltage supply, alignment layers (e.g., 320 and 322 of FIG. 3A) adjacent to the electrode layers, and a layer of LC molecules (e.g., 340 of FIG. 3A) embedded between the alignment layers. The alignment layers include a polymer (e.g., 330 and 332 of FIG. 3A) to be formed with a combination of an electron-donor monomer and an electron-acceptor monomer. The alignment layers include grooves, and the LC molecules are enabled to align along the grooves when no voltage is applied to the electrode layers.

In some implementations, the electrode layers include an anode and a cathode, wherein the alignment layers comprise a first alignment layer and a second alignment layer adjacent to the anode and the cathode, respectively.

In one or more implementations, the grooves include linearly oriented grooves, wherein the LC molecules are enabled to align along the linearly oriented grooves when no voltage is applied to the electrode layers.

In some implementations, the grooves include linearly oriented grooves, wherein the LC molecules are enabled to disengage from the alignment layers when a voltage is applied to the electrode layers.

In one or more implementations, a first alignment layer of the alignment layers adjacent to the anode includes the electron-donor monomer configured to oxidize at a first threshold below a first voltage applied to the anode.

In some implementations, a second alignment layer of the alignment layers adjacent to the cathode includes the electron-acceptor monomer configured to reduce at a second threshold above a second voltage applied to the cathode.

In one or more implementations, the grooves include linearly oriented grooves perpendicular to each other, wherein the LC molecules are formed in a cholesteric configuration.

In some implementations, the grooves include linearly oriented grooves parallel with each other, wherein the LC molecules are formed in a nematic or a smectic configuration.

Yet another aspect of the disclosure is related to a method including forming a first multilayer structure (e.g., including 310, 320 and 330 of FIG. 3A) over a first glass substrate (e.g., 204 of FIG. 2B) and forming a second multilayer structure (e.g., including 312, 322 and 332 of FIG. 3A) over a second glass substrate (e.g., 214 of FIG. 2B). The method further includes embedding an LC material layer (e.g., 340 of FIG. 3A) between the first multilayer structure and the second multilayer structure. The first multilayer structure includes a first electrode (e.g., 310 of FIG. 3A), a first alignment layer (e.g., 320 of FIG. 3A) and a first polymer layer (e.g., 330 of FIG. 3A). The second multilayer structure includes a second electrode (e.g., 312 of FIG. 3A), a second alignment layer (e.g., 322 of FIG. 3A) and a second polymer layer (e.g., 332 of FIG. 3A). The first polymer layer and the second polymer layer include a combination of an electron-donor monomer and an electron-acceptor monomer.

In some implementations, the method further includes embedding the LC material and further includes forming the LC material layer between the polymer layers of the first multilayer structure and the second multilayer structure.

In one or more implementations, the method further includes forming a first set of linearly oriented parallel grooves over the polymer layer of the first multilayer structure enabling molecules of the LC material layer to be formed in a nematic or a smectic configuration.

In some implementations, the method further includes forming a second set of linearly oriented orthogonal grooves over the polymer layer of the second multilayer structure enabling the molecules of the LC material layer to be formed in a cholesteric configuration.

In some implementations, the first electrode includes an anode, and the alignment layer of the first multilayer structure includes the electron-doner monomer and includes an oxidizer enabled at a first threshold below a first voltage applied to the anode.

In one or more implementations, the second electrode includes a cathode, and the alignment layer of the second multilayer structure includes the electron-acceptor monomer including a reducer enabled at a second threshold above a second voltage applied to the cathode.

In some implementations, the word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially described as such, one or more features from a described combination can in some cases be excised from the combination, and the described combination may be directed to a sub-combination or variation of a sub-combination.

The subject matter of this specification has been described in terms of particular aspects, but other aspects can be implemented and are within the scope of the following clauses. For example, while operations are depicted in the drawings in a particular order, this should not be understood as requiring that such operations be performed in the particular order shown or in sequential order, or that all illustrated operations be performed, to achieve desirable results. The actions recited in the clauses can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the clauses. In addition, in the detailed description, it can be seen that the description provides illustrative examples, and the various features are grouped together in various implementations for the purpose of streamlining the disclosure. The method of disclosure is not to be interpreted as reflecting an intention that the described subject matter requires more features than are expressly recited in each clause. Rather, as the clauses reflect, inventive subject matter lies in less than all features of a single disclosed configuration or operation. The clauses are hereby incorporated into the detailed description, with each clause standing on its own as a separately described subject matter.

Aspects of the subject matter described in this disclosure can be implemented to realize one or more of the following potential advantages. The described techniques may be implemented to support a range of benefits and significant advantages of the disclosed eye tracking system. It should be noted that the subject technology enables fabrication of a depth-sensing apparatus that is a fully solid-state device with small size, low power, and low cost.

As used herein, the phrase “at least one of” preceding a series of items, with the terms “and” or “or” to separate any of the items, modifies the list as a whole, rather than each member of the list (i.e., each item).

To the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A display cell, comprising:
two electrodes configured to be electrically coupled with a voltage supply;
two alignment layers formed over surfaces of the two electrodes; and
a liquid crystal (LC) material layer embedded between the two alignment layers,
wherein:
the alignment layers includes grooves,
molecules of the LC material layer are enabled to align along the grooves when no voltage is applied to the two electrodes, and
the two alignment layers include a polymer formed with a combination of an electron-donor monomer and an electron-acceptor monomer.

2. The display cell of claim 1, wherein the surfaces of the two electrodes are facing the LC material layer.

3. The display cell of claim 1, wherein the molecules of the LC material layer are enabled to disengage from the alignment layers when voltage is applied to the two electrodes.

4. The display cell of claim 1, wherein the two electrodes include an anode and a cathode, wherein the two alignment layers comprise a first alignment layer and a second alignment layer adjacent to the anode and the cathode, respectively.

5. The display cell of claim 4, wherein the first alignment layer comprises an electron-donor monomer configured to oxidize at a first threshold below a first voltage applied to the anode.

6. The display cell of claim 4, wherein the second alignment layer comprises an electron-acceptor monomer configured to reduce at a second threshold above a second voltage applied to the cathode.

7. The display cell of claim 4, wherein the grooves comprise linearly oriented grooves, wherein the linearly oriented grooves are perpendicular to each other, and wherein the molecules of the LC material layer are formed in a cholesteric configuration.

8. The display cell of claim 7, wherein the linearly oriented grooves are parallel to each other, and wherein the molecules of the LC material layer are formed in a nematic or a smectic configuration.

9. A display panel, comprising:
an LC panel including a plurality of LC cells arranged in a planar configuration;
each LC cell of the plurality of LC cells comprising:
electrode layers configured to be electrically coupled with a voltage supply;
alignment layers adjacent to the electrode layers; and
a layer of LC molecules embedded between the alignment layers,
wherein:
the alignment layers include a polymer formed with a combination of an electron-donor monomer and an electron-acceptor monomer,
the alignment layers include grooves, and
the LC molecules are enabled to align along the grooves when no voltage is applied to the electrode layers.

10. The display panel of claim 9, wherein the electrode layers comprise an anode and a cathode, and wherein the alignment layers comprise a first alignment layer and a second alignment layer adjacent to the anode and the cathode, respectively.

11. The display panel of claim 10, wherein the grooves comprise linearly oriented grooves, and wherein the LC molecules are enabled to align along the linearly oriented grooves when voltage is applied to the electrode layers.

12. The display panel of claim 10, wherein the grooves comprise linearly oriented grooves, and wherein the LC molecules are enabled to disengage from the alignment layers when a voltage is applied to the electrode layers.

13. The display panel of claim 10, wherein a first alignment layer of the alignment layers adjacent to the anode comprises the electron-donor monomer configured to oxidize at a first threshold below a first voltage applied to the anode.

14. The display panel of claim 10, wherein a second alignment layer of the alignment layers adjacent to the cathode comprises the electron-acceptor monomer configured to reduce at a second threshold above a second voltage applied to the cathode.

15. The display panel of claim 9, wherein the grooves comprise linearly oriented grooves perpendicular to each other, and wherein the LC molecules are formed in a cholesteric configuration.

16. The display panel of claim 9, wherein the grooves comprise linearly oriented grooves parallel with each other, and wherein the LC molecules are formed in a nematic or a smectic configuration.

17. A method comprising:
forming a first multilayer structure over a first glass substrate;
forming a second multilayer structure over a second glass substrate; and
embedding an LC material layer between the first multilayer structure and the second multilayer structure,
wherein:
the first multilayer structure comprises a first electrode, a first alignment layer including a first polymer layer,
the second multilayer structure comprises a second electrode, a second alignment layer including a second polymer layer, and
the first polymer layer and the second polymer layer include a combination of an electron-donor monomer and an electron-acceptor monomer.

18. The method of claim 17, wherein embedding the LC material comprises forming the LC material layer between the first polymer layer and the second polymer layer.

19. The method of claim 17, further comprising forming:
a first set of linearly oriented parallel grooves over the first polymer layer enabling molecules of the LC material layer to be formed in a nematic or a smectic configuration; and
a second set of linearly oriented orthogonal grooves over the second polymer layer enabling the molecules of the LC material layer to be formed in a cholesteric configuration.

20. The method of claim 17, wherein:
the first electrode comprises an anode, and the first alignment layer comprises the electron-donor monomer including an oxidizer enabled at a first threshold below a first voltage applied to the anode, and
the second electrode comprises a cathode, and the second alignment layer comprises the electron-acceptor monomer including a reducer enabled at a second threshold above a second voltage applied to the cathode.
